(19) United States
(12) Patent Application Publication
(10) Pub. No.: US 2023/0297785 A1
(43) Pub. Date: Sep. 21, 2023

(54) REAL-TIME NOTIFICATION OF DISCLOSURE ERRORS IN INTERACTIVE COMMUNICATIONS

(71) Applicant: Capital One Services, LLC, McLean, VA (US)

(72) Inventors: Nicholas LAMM, Brooklyn, NY (US); Aysu Ezen CAN, Cary, NC (US)

(73) Assignee: Capital One Services, LLC, McLean, VA (US)

(21) Appl. No.: 17/698,025

(22) Filed: Mar. 18, 2022

(51) Int. Cl. G06F 40/35; H04M 3/51; G06F 40/166; G06F 40/284; G10L 15/22; G10L 15/16

(52) U.S. Cl. CPC G06F 40/35; H04M 3/5166; G06F 40/166; G06F 40/284; G10L 15/22; G10L 15/16

(57) ABSTRACT

Disclosed herein are system, method, and computer program product embodiments for machine learning systems to process incoming call-center calls to provide regulatory disclosure compliance. An incoming call is routed to a call agent based on an inferred topic, classified based on a specific regulatory disclosure, analyzed to detect a specific regulatory disclosure within a call agent's call dialog, and analyzed to determine if a current reading of the specific regulatory disclosure is noncompliant. The system automatically suggests one or more phrases to the call agent for use in the dialog to convert the dialog to compliant.

### BACKGROUND

Text and speech may be analyzed by computers to discover words and sentences. However, missing in current computer-based text/speech analyzers is an ability to recognize incomplete but legally required disclosures presented to a caller during an interactive communication. A disclosure may be read by a call agent to meet regulatory compliance during a call with a customer. As a consequence, if they omit one or more words or they completely forget to read the correct disclosure, they may not meet regulatory compliance during the communication.

### BRIEF DESCRIPTION OF THE DRAWINGS

The accompanying drawings are incorporated herein and form a part of the specification.

FIG. 1 is a flow diagram for a call center system processing an incoming call, according to some embodiments.

FIG. 2 is a block diagram for real-time call disclosure analysis and assistance, according to some embodiments.

FIG. 3 is a block diagram for natural language processing of an incoming call, according to some embodiments.

FIG. 4 is a block diagram for processing an incoming call with machine learning, according to some embodiments.

FIG. 5 is a flow diagram for real-time call processing, according to some embodiments.

FIG. 6 illustrates multiple examples of real-time support for agents, as per some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof to provide real-time support to call center agents to improve regulatory compliance. Regulatory compliance is core to many businesses. A call agent reading of a required disclosure may be a crucial aspect of informing customers of disclosure information in a quick and effective manner. Additionally, there may be business value in improving a customer experience in terms of both company reputation and customer retention.

Customer call centers lie at the heart of an interaction between businesses and their customers. Businesses receive calls every month that involve customer-agent interactions that address customer issues ranging from a straightforward address-change request to other interactions involving, for example, specific account or loan information (e.g., payments). Resolving such issues is complex because it requires understanding customers, quickly finding a solution and providing proper disclosure information while solving each problem addressed. Call center agents are a precious resource: costly and limited in number. Therefore, it is of the utmost importance to provide them as much assistance as possible during calls so that interactions are fast, resolve the issue, and provide a top-notch customer experience all while ensuring proper disclosure information has been provided. Disclosures may be directed to legal requirements (e.g., consumer rights, privacy declarations, company use of personal information, etc.), financial requirements (e.g., interest rates, loan terms, early termination clauses, etc.) and/or regulatory requirements (e.g., any terms dictated by government agencies or banking industry groups). While stated as a separate category, regulatory requirements may include any type of disclosure.

In various embodiments, real-time assistance is provided while a call is in progress in order to ensure regulatory compliance by making sure that the call agent has properly read required disclosures associated with the subject matter of a current call.

There are many scenarios where a call center agent (call agent) must read a disclosure statement to a customer in order to adhere to a regulatory requirement. In call centers, it is typical for an agent to have access to a software or a web interface that guides them through the interaction. When a disclosure statement is required to be read in an interaction, the system will notify the agent and provide the disclosure text. For instance, when a customer calls to make a payment over the phone, the system prompts the call agent to read a disclosure statement that includes information about the payment transaction. In one non-limiting example, a payment disclosure is read as noted below:

Payment Disclosure: “[Customer_Name], today you are authorizing a one-time payment of [Payment] that will be debited on or after [Effective_Payment_Date] from your bank account ending in [Last Four_Digits_of_Bank_Account]. For questions about this payment or to cancel the payment before it starts processing, please call: [Product_Specific_Phone_Number]. Do you agree to these terms?”

A system that prompts the call agent to read a disclosure can be an effective way to remind the agent to perform this action. However, there are many instances in which regulatory errors still occur. The call agent might mistakenly leave out a key component of the disclosure statement when reading it. The call agent might be side tracked by the customer asking questions, and neglect to read the disclosure statement completely. In some scenarios, the call agent might disregard the prompt entirely or read the wrong disclosure. In all of these cases, the call agent may have committed a regulatory error. Post hoc analyses, such as random sampling of calls for review can reveal some of these errors, resulting in remediation steps (e.g., training) for the call agent. However, this does not prevent the regulatory error from occurring and it may also be highly time consuming.

In some embodiments, the technology described herein provides a real-time system that notifies call agents of incomplete disclosures (including no disclosure read at all) and allows for the call agent to correct their mistake during the call, avoiding a regulatory error. This correction, in real-time, provides a real-world technical improvement to call center analysis technology, where the technical improvement is rooted in the computer system itself.

In some embodiments, the technology described herein includes a plurality of machine learning models related to disclosure tasks combined in an infrastructure to support call center agents in real-time while interacting with customers.

In some embodiments, the technology described herein provides processing of incoming call-center calls based on inferred (machine learning model) subject matter. For example, an incoming call is routed to a call agent based on an inferred topic (obtaining a new credit card). This call is recorded and may be classified based on one or more topics derived from a current caller's speech. A real-time disclosure compliance machine learning model may determine, based on the call classification, that a salient disclosure has been read, not read, or read but not read completely, and initiate an automated assistance (automated assistance machine learning model) by searching for incorrect or missing wording, words, phrases, or numeric information, occurring during the current call. Successful call outcomes (full disclosure compliance) may be achieved by the system suggesting one or more words/phrases to the call agent for use in a dialog with the current caller to complete the disclosure reading. For instance, for a Payment Disclosure, a common agent error is to leave out a final sentence asking for the customer's consent. A real-time system will alert the agent that they omitted this important component, and the agent can avoid the potential error by asking the question during the call.

In some embodiments, call center managers may be alerted so that they can decide whether to tune in to a particularly problematic call or to provide assistance.

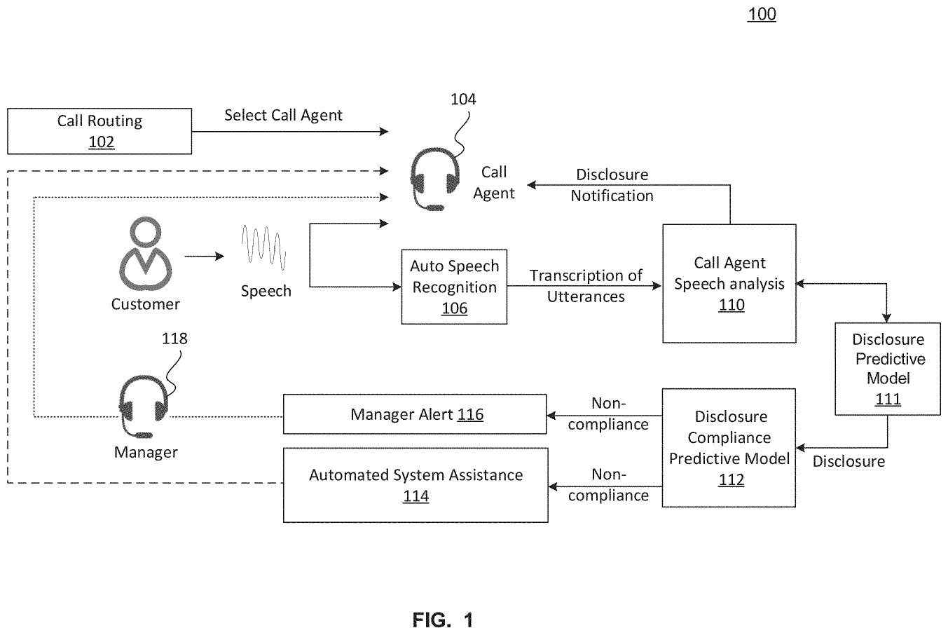

FIG. 1 is a flow diagram for a call center system processing an incoming call, according to some embodiments. As shown, call center system 100 processes an incoming interactive communication, such as a customer call. System 100 may be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all modules may be needed to perform the disclosure provided herein. Further, some of the processes described may be performed simultaneously, or in a different order or arrangement than shown in FIG. 1, as will be understood by a person of ordinary skill in the art.

System 100 shall be described with reference to FIG. 1. However, system 100 is not limited to this example embodiment. In addition, system 100 will be described at a high level to provide an overall understanding of one example call flow from incoming call to call agent assistance. Greater detail will be provided in the figures that follow.

Incoming call center calls are routed to a call agent 104 through a call routing module 102. Call routing module 102 may analyze pre-call information, such as a caller's profile, previous call interactions, voice menu selections or inputs to automated voice prompts. Call agents may be segmented into groups by subject matter expertise, such as experience with specific subjects or subject matter customer complaints. Understanding which call agent to route the incoming call to may ultimately determine a successful outcome, reduce call time and enhance a customer's experience.

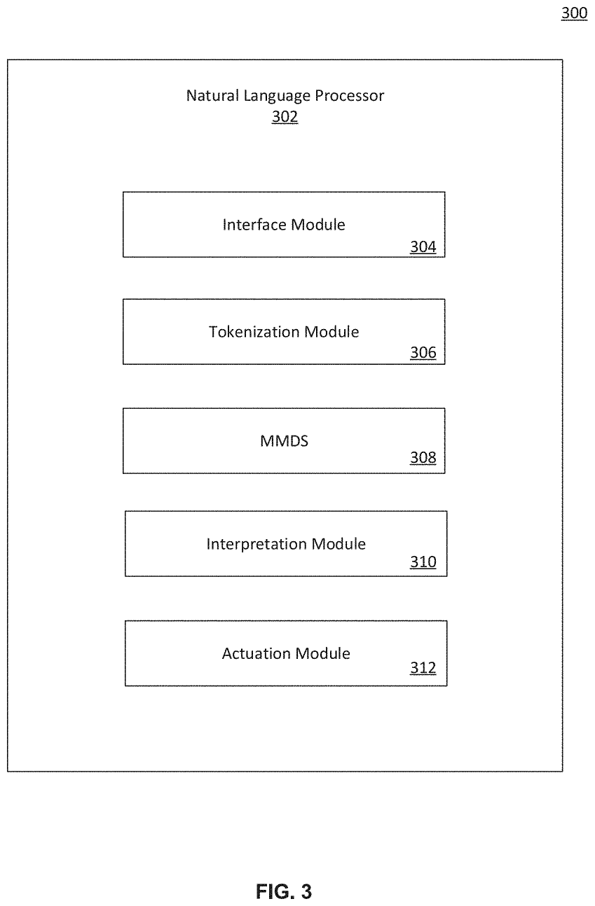

Once a call agent 104 is selected, Automatic Speech Recognition (ASR) module 106 may analyze the incoming caller's speech and call agent's speech in real time by sequentially analyzing utterances. Utterances may include a spoken word, statement, or vocal sound. However, utterances may be difficult to analyze without a proper understanding of how, for example, one utterance relates to another utterance. Languages follow known constructs (e.g., semantics), patterns, rules and structures. Therefore, these utterances may be analyzed using a systematic approach (described in greater detail in FIG. 3). For example, the ASR module 106 may process natural language processing (NLP) tasks. The NLP tasks may include, for example, text translation, text summarization, text generation, sentence analysis and completion or similar NLP tasks performed by computers. In some embodiments, the speech of a caller and that of a call agent are identified as separate text strings and recorded accordingly. While not described herein, it is to be understood that the caller's and call agent's speech are separated using known voice processing techniques.

In one embodiment, a text string (e.g., transcription of utterances) of the call agent may be communicated from ASR module 106 to call agent speech analysis module 110. In another embodiment, the text string may be received from a repository, database, or computer file that contains the text string. For example, in one embodiment, the text string may be generated by the ASR module 106 and saved to a repository, database, or computer file, such as a .txt file or Microsoft Word (TM) file, as examples, for retrieval and receipt by call agent analysis module 110.

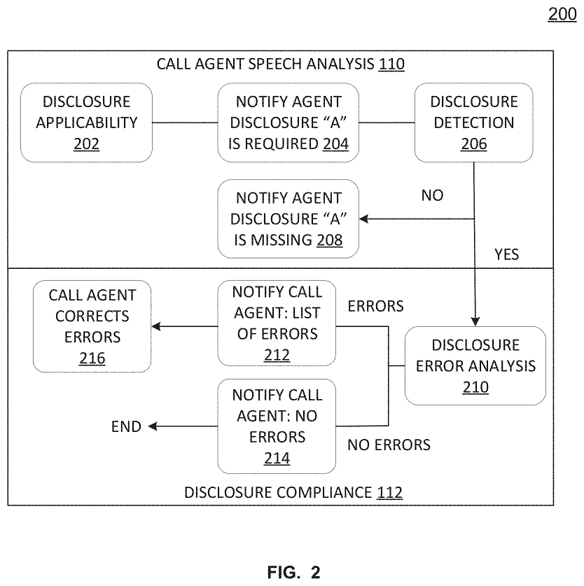

As will be described in greater detail in FIG. 2, call agent speech analysis module 110 subsequently analyzes the text of the call to determine, based on matching, whether a disclosure is or is not being voiced by the call agent. For example, the call agent speech analysis module 110 may perform an analysis of the words spoken by the call agent and include a match analysis to existing disclosures based, at least in-part, on disclosure predictive model 111.

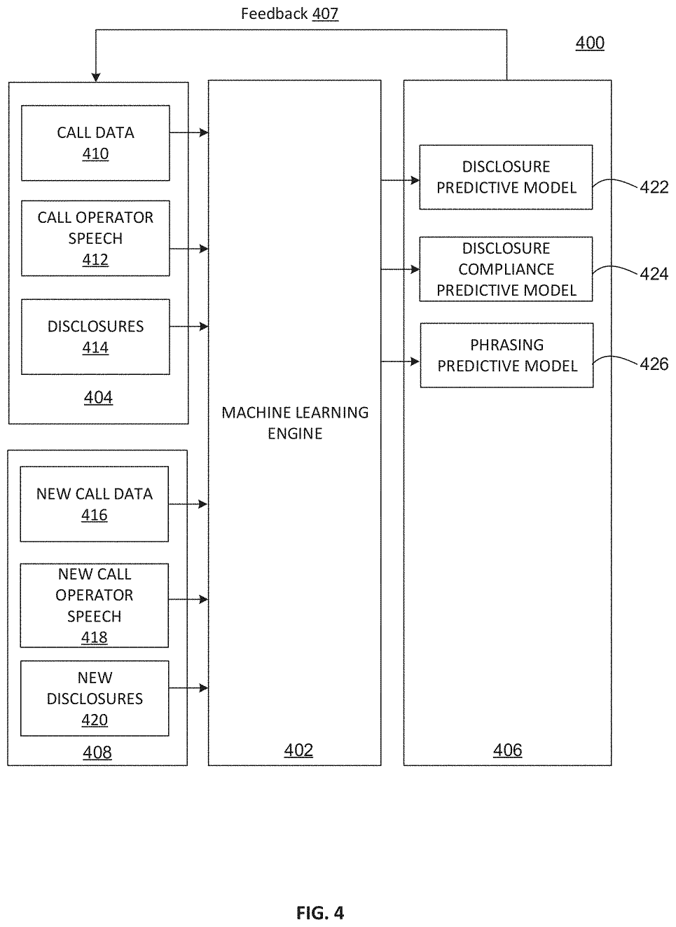

Disclosure predictive model 111, may include a machine learning model trained as described in greater detail in FIG. 4. The disclosure predictive model 111 is trained to predict, as transcription utterances are being analyzed by call agent speech analysis module 110, if a disclosure is currently being read by call agent 104 during the call. If it is determined that a disclosure is not being read, the disclosure predictive model 111 may identify a specific disclosure that is required to be read by the call agent 104. This determination is based, at least in part, by the call agent speech analysis module 110 identifying matching utterances from known disclosures. If a disclosure is required to be read by the call agent 104, the call agent speech analysis module may notify the agent directly or through the automated system assistance module 114 to read the disclosure. In some embodiments, the text of the disclosure to be read by the call agent 104 is communicated to a call agent's display. In some embodiments, no disclosure requirement exists for the analyzed utterances and the system continues to analyze the call agent utterances for potential future disclosure requirements (e.g., later in the call).

If it is determined that a disclosure is being read, the disclosure predictive model 111 may subsequently identify a specific disclosure being read by the call agent 104. This prediction is based, at least in-part, on a classification score of the utterances representing a positive comparison above a threshold to previously stored disclosure text.

Disclosure compliance module 112, based on matching, may subsequently determine if errors in a reading of the disclosure occurred or that no errors occurred. When errors are detected, the data is forwarded to an automated assistance module 114.

Automated assistance module 114 subsequently analyzes the disclosure compliance results to determine phrases that are considered relevant to completing the disclosure reading task. These phrases are selected and communicated to call agent 104. For example, a call agent may receive phrases displayed on their computer screen. Phrases may include, or be combined with, introductory phrases or additional contextual information, such as product descriptions, customer options or steps that may provide further technical assistance.

In some embodiments, if the disclosure process is not completed within a set time period, a manager alert module 116 may be triggered to provide experienced managerial level assistance (manager 118) for the agent in handling the current call.

FIG. 2 is a block diagram for real-time call disclosure analysis and assistance, according to some embodiments. The modules described may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100 or installed as a removable portion of the system 100.

As shown, call agent speech analysis module 110 is configured to determine what type of disclosure is required to be read, if any. Disclosure applicability module 202 may use a predictive model (FIG. 4) to determine, based on utterances of the caller and/or the call agent, a corresponding “best match” disclosure that should be read during handling of the call. Based on a best match equaling “Disclosure A”, in 204, the system notifies the call agent that disclosure “A” is required. In some embodiments, no “best match” will occur and therefore no notification is required. Alternately, or in addition, the system notifies the call agent that no disclosure is needed (not shown).

Disclosure detection module 206 adapts a string-matching algorithm, such as a Ratcliff/Obershelp string-matching algorithm, to detect disclosures in call center transcripts. Edit distance may be calculated to find the number of string operations (e.g., add, subtract, replace) necessary to match the correct disclosure. The operations are then suggested to the agent (e.g., remove ‘not’ in second sentence and read it again). If no disclosure is detected, in 208, the call agent is notified that disclosure “A” is missing (and therefore should be read). In this scenario, the disclosure may be provided, for example, on a screen of the call agent. If at least a partial disclosure is detected, the disclosure compliance module 112 continues to process the call.

In some aspects, disclosure error analysis module 210 is configured to use a Ratcliff/Obershelp string-matching algorithm to calculate a similarity between two sequences: the disclosure statement, and the agent's words. Each of the two text inputs is transformed into a sequence of tokens (FIG. 3). The sequence of agent words is further divided into sliding windows. Each window is compared against the disclosure sequence, and an overlap score is computed. The segment of agent words with the highest score is returned. If errors are detected, in 212, the call agent is notified and provided a list of the errors that are subsequently, in 216, corrected by the call agent. If no errors were found, the call agent, in 214, is notified that no errors occurred and the disclosure compliance processing is terminated.

The following non-limiting list of examples are common types of errors made by agents while reading, for example, a Payment Disclosure.

### EXAMPLE 1

### Error:

Agent omits the phrase “or to cancel the payment before it starts processing,” neglecting to explain that the customer can call to cancel the payment before it processes. The agent is notified of the error and makes a correction.

### Disclosure:

Payment Disclosure: “[Customer_Name], today you are authorizing a one-time payment of [Payment] that will be debited on or after [Effective_Payment_Date] from your bank account ending in [Last_Four_Digits_of_Bank_Account]. For questions about this payment or to cancel the payment before it starts processing, please call: [Product_Specific_Phone_Number]. Do you agree to these terms?”

### Transcribed Dialogue:

Agent: And you are the primary user on this account, is this correct?
Customer: Yeah
Agent: Ok
Agent: Alright, perfect. [Name], today you are authorizing a one-time payment of one hundred dollars that will be debited on or after [Date] from the bank account ending in [4 Digits]. For questions about this payment, please call [Service Number]. Do you agree to these terms?
Customer: Yes
[Agent received notification that the phrase “or to cancel the payment before it starts processing” is missing]
Agent: You can also call [Service Number] if you want to cancel the payment before it starts processing.

### EXAMPLE 2

### Error:

Agent neglects to include the payment amount. The agent is notified of the error and makes a correction by including the payment amount in the subsequent utterance.

### Disclosure:

Payment Disclosure: “[Customer_Name], today you are authorizing a one-time payment of [Payment] that will be debited on or after [Effective_Payment_Date] from your bank account ending in [Last_Four_Digits_of_Bank_Account]. For questions about this payment or to cancel the payment before it starts processing, please call: [Product_Specific_Phone_Number]. Do you agree to these terms?”

### Transcribed Dialogue:

Agent: Do you have any questions first?
Customer: No
Agent: OK. I need to read you a disclosure before I process the payment. You are authorizing a one-time payment on or after January the fifth 2020 from your bank account ending in [4 Digits]. For questions about this payment or to cancel the payment before processing, please call [Service Number]. Do you agree to these terms?
Customer: Yeah, sounds good, OK.
[Agent received notification that the payment amount is missing]
Agent: Now that payment you are authorizing is for three hundred dollars.

### EXAMPLE 3

### Error:

Agent neglects to include the payment date. Agent is presented with a notification that they are missing the payment date, and consequently the agent makes a correction by including the payment date in the subsequent utterance.

### Disclosure:

Payment Disclosure: “[Customer_Name], today you are authorizing a one-time payment of [Payment] that will be debited on or after [Effective_Payment_Date] from your bank account ending in [Last_Four_Digits_of_Bank_Account]. For questions about this payment or to cancel the payment before it starts processing, please call: [Product_Specific_Phone Number]. Do you agree to these terms?”

### Transcribed Dialogue:

Customer: I wanted to make a quick payment. I know it's not due yet, but I still wanted to.
Agent: Absolutely. I'm happy to help and take care of your payment today. I'll just need to confirm, what is your last name and date of birth, please?
Customer: [Name], [Date of Birth]
Agent: OK, I have access right to your account ending in [4 Digits], and I can see here that on this account the balance we have is exactly two hundred dollars and nineteen cents.
Customer: I want to pay one hundred dollars.
Agent: Absolutely. Now I'll be providing you with some terms and conditions before processing the payment. Please let me know if you have any additional questions about the payments. Now [Name], today you're authorizing a one-time payment of one hundred dollars from the bank account ending in [4 Digits]. For questions about this payment or to cancel the payment before it starts processing, please give us a call at [Service Number].
[Agent received notification that the payment date is missing]
Agent: And this payment will be debited on or after Jan. 12, 2021. Do you agree to these terms?
Customer: Yes okay.

FIG. 3 is a block diagram of a Natural Language Processor (NLP) system 300, according to some embodiments. The number of components in system 300 is not limited to what is shown and other variations in the number of arrangements of components are possible, consistent with some embodiments disclosed herein. The components of FIG. 3 may be implemented through hardware, software, and/or firmware. As used herein, the term non-recurrent neural networks, which includes transformer networks, refers to machine learning processes and neural network architectures designed to handle ordered sequences of data for various natural language processing (NLP) tasks. NLP tasks may include, for example, text translation, text summarization, text generation, sentence analysis and completion, determination of punctuation, or similar NLP tasks performed by computers.

As illustrated, system 300 may comprise a Natural Language Processor (NLP) 302. NLP 302 may include any device, mechanism, system, network, and/or compilation of instructions for performing natural language recognition of call agent's transcripts and associated reading of disclosures consistent with the technology described herein. In the configuration illustrated in FIG. 3, NLP 302 may include an interface module 304, a tokenization module 306, a Master and Metadata Search (MMDS) module 308, an interpretation module 310, and an actuation module 312. In certain embodiments, modules 304, 306, 308, 310, and 312 may each be implemented via any combination of hardware, software, and/or firmware.

Interface module 304 may serve as an entry point or user interface through which one or more utterances, such as spoken words/sentences (speech), may be entered for subsequent recognition using an automatic speech recognition model. While described for spoken words throughout the application, text may also be analyzed and processed using the technology described herein. For example, a pop-up chat session may be substituted for spoken words. In another embodiment, text from emails may be substituted for spoken words. In yet another embodiment, spoken words converted to text or text converted to spoken words, such as for blind or deaf callers, may be substituted without departing from the scope of the technology described herein.

In certain embodiments, interface module 304 may facilitate information exchange among and between NLP 302 and one or more call agent systems. Interface module 304 may be implemented by one or more software, hardware, and/or firmware components. Interface module 304 may include one or more logical components, processes, algorithms, systems, applications, and/or networks. Certain functions embodied by interface module 304 may be implemented by, for example, HTML, HTML with JavaScript, C/C++, Java, etc. Interface module 304 may include or be coupled to one or more data ports for transmitting and receiving data from one or more components coupled to NLP 302. Interface module 304 may include or be coupled to one or more user interfaces (e.g., a speaker, microphone, headset, or GUI).

In certain configurations, interface module 304 may interact with one or more applications running on one or more computer systems. Interface module 304 may, for example, embed functionality associated with components of NLP 302 into applications running on a computer system. In one example, interface module 304 may embed NLP 302 functionality into a Web browser or interactive menu application with which a user (call agent) interacts. For instance, interface module 304 may embed GUI elements (e.g., dialog boxes, input fields, textual messages, etc.) associated with NLP 302 functionality in an application with which a user interacts. Details of applications with which interface module 304 may interact are discussed in connection with FIGS. 1-7.

In certain embodiments, interface module 304 may include, be coupled to, and/or integrate one or more systems and/or applications, such as speech recognition facilities and Text-To-Speech (TTS) engines. Further, interface module 304 may serve as an entry point to one or more voice portals. Such a voice portal may include software and hardware for receiving and processing instructions from a user via voice. The voice portal may include, for example, a voice recognition function and an associated application server. The voice recognition function may receive and interpret dictation, or recognize spoken commands. The application server may take, for example, the output from the voice recognition function, convert it to a format suitable for other systems, and forward the information to those systems.

Consistent with embodiments of the present invention, interface module 304 may receive natural language queries (e.g., word, phrases or sentences) from a call agent and forward the queries to tokenization module 306.

Tokenization module 306 may transform natural language queries into semantic tokens. Semantic tokens may include additional information, such as language identifiers, to help provide context or resolve meaning. Tokenization module 306 may be implemented by one or more software, hardware, and/or firmware components. Tokenization module 304 may include one or more logical components, processes, algorithms, systems, applications, and/or networks. Tokenization module 306 may include stemming logic, combinatorial intelligence, and/or logic for combining different tokenizers for different languages. In one configuration, tokenization module 306 may receive an ASCII string and output a list of words. Tokenization module 306 may transmit generated tokens to MMDS module 308 via standard machine-readable formats, such as the eXtensible Markup Language (XML).

MMDS module 308 may be configured to retrieve information using tokens received from tokenization module 306. MMDS module 308 may be implemented by one or more software, hardware, and/or firmware components. MMDS module 308 may include one or more logical components, processes, algorithms, systems, applications, and/or networks. In one configuration, MMDS module 308 may include an API, a searching framework, one or more applications, and one or more search engines.

MMDS module 308 may include an API, which facilitates requests to one or more operating systems and/or applications included in or coupled to MMDS module 308. For example, the API may facilitate interaction between MMDS 308 and one or more structured data archives (e.g., knowledge base).

In certain embodiments, MMDS module 308 may be configured to maintain a searchable data index, including metadata, master data, metadata descriptions, and/or system element descriptions. For example, the data index may include readable field names (e.g., textual) for metadata (e.g., table names and column headers), master data (e.g., individual field values), and metadata descriptions. The data index may be implemented via one or more hardware, software, and/or firmware components. In one implementation, a searching framework within MMDS 308 may initialize the data index, perform delta indexing, collect metadata, collect master data, and administer indexing. Such a searching framework may be included in one or more business intelligence applications (e.g., helpdesk, chatbots, voice interactive modules, etc.)

In certain configurations, MMDS module 308 may include or be coupled to a low level semantic analyzer, which may be embodied by one or more software, hardware, and/or firmware components. The semantic analyzer may include components for receiving tokens from tokenization module 306 and identifying relevant synonyms, hypernyms, etc. In one embodiment, the semantic analyzer may include and/or be coupled to a table of synonyms, hypernyms, etc. The semantic analyzer may include components for adding such synonyms as supplements to the tokens.

Consistent with embodiments of the present invention, MMDS module 308 may leverage various components and searching techniques/algorithms to search the data index using tokens received by tokenization module 306. MMDS module 308 may leverage one or more search engines that employ partial/fuzzy matching processes and/or one or more Boolean, federated, or attribute searching components.

In certain configurations, MMDS module 308 may include and/or leverage one or more information validation processes. In one configuration, MMDS module 308 may leverage one or more languages for validating XML information. MMDS module 308 may include or be coupled to one or more clients that include business application subsystems.

In certain configurations, MMDS module 308 may include one or more software, hardware, and/or firmware components for prioritizing information found in the data index with respect to the semantic tokens. In one example, such components may generate match scores, which represent a qualitative and/or quantitative weight or bias indicating the strength/correlation of the association between elements in the data index and the semantic tokens.

In one configuration, MMDS module 308 may include one or more machine learning components to enhance searching efficacy as discussed further in association with FIG. 3. In one example, such a learning component may observe and/or log information requested by callers and may build additional and/or prioritized indexes for fast access to frequently requested data. Learning components may exclude frequently requested information from the data index, and such MMDS data may be forwarded to and/or included in interpretation module 310.

MMDS module 308 may output to interpretation module 310 a series of meta and/or master data technical addresses, associated field names, and any associated description fields. MMDS module 308 may also output matching scores to interpretation module 310.

Interpretation module 310 may process and analyze results returned by MMDS module 308. Interpretation module 310 may be implemented by one or more software, hardware, and/or firmware components. Interpretation module 310 may include one or more logical components, processes, algorithms, systems, applications, and/or networks. In one example, interpretation module 310 may include an agent network, in which agents make claims by matching policy conditions against tokenized natural language queries and context information.

Consistent with embodiments of the present invention, interpretation module 310 may be configured to recognize information identified by MMDS 308. For example, interpretation module 310 may identify ambiguities, input deficiencies, imperfect conceptual matches, and compound commands. In certain configurations, interpretation module 310 may initiate, configure, and manage user dialogs; specify and manage configurable policies; perform context awareness processes; maintain context information; personalize policies and perform context switches; and perform learning processes.

Interpretation module 310 may provide one or more winning combinations of data elements to actuation module 312. Interpretation module 310 may filter information identified by MMDS module 310 in order to extract information that is actually relevant to spoken inputs. That is, interpretation module 310 may distill information identified by MMDS module 308 down to information that is relevant to the words/sentences and in accordance with intent. Information provided by interpretation module 310 (i.e., winning combination of elements) may include function calls, metadata, and/or master data. In certain embodiments, the winning combination of elements may be arranged in specific sequence to ensure proper actuation. Further, appropriate relationships and dependencies among and between various elements of the winning combinations may be preserved/maintained. For example, meta and master data elements included in a winning combination may be used to populate one or more function calls included in that winning combination.

Actuation module 312 may process interpreted information provided by interpretation module 310. Actuation module 312 may be implemented by one or more software, hardware, and/or firmware components. Actuation module 312 may include one or more logical components, processes, algorithms, systems, applications, and/or networks. Actuation module 312 may be configurable to interact with one or more system environments.

Consistent with embodiments of the present invention, actuation module 312 may be configured to provide information to one or more users/systems. In such embodiments, actuation module may interact with one or more information display devices.

In certain embodiments, actuation module 312 may be configured to send requests to one or more devices and/or systems using, for example, various APIs. Actuation module 312 may generate one or more presentations based on responses to such commands.

For clarity of explanation, interface module 304, tokenization module 306, MMDS module 308, interpretation module 310, and actuation module 312 are described as discrete functional elements within NLP 302. However, it should be understood that the functionality of these elements and modules may overlap and/or may exist in fewer elements and modules. Moreover, all or part of the functionality of these elements may co-exist or be distributed among several geographically-dispersed locations.

FIG. 4 is a block diagram of a machine learning system, according to some embodiments. A machine learning system 400 may include a machine learning engine 402 of one or more servers (cloud or local) processing audio text (speech), such as words, phrases or sentences, to recognize relationships of words (e.g., within sentences) received by natural language system 300. As described in various embodiments, machine learning engine 402 may be used to detect disclosure applicability, detect disclosures being read to the caller, recognize disclosure compliance, and provide relevant phrasing to provide real-time disclosure corrections to a call agent. While described in stages, the sequence may include more or less stages or be performed in a different order.

Machine learning involves computers discovering how they can perform tasks without being explicitly programmed to do so. Machine learning (ML) includes, but is not limited to, artificial intelligence, deep learning, fuzzy learning, supervised learning, unsupervised learning, etc. Machine learning algorithms build a model based on sample data, known as “training data”, in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning). Machine learning engine 402 may uses various classifiers to map concepts associated with a specific language structure to capture relationships between concepts and words/phrases/sentences. The classifier (discriminator) is trained to distinguish (recognize) variations. Different variations may be classified to ensure no collapse of the classifier and so that variations can be distinguished.

Machine learning may involve computers learning from data provided so that they carry out certain tasks. For more advanced tasks, it can be challenging for a human to manually create the needed algorithms. This may be especially true of teaching approaches to correctly identify speech patterns within varying speech structures. The discipline of machine learning therefore employs various approaches to teach computers to accomplish tasks where no fully satisfactory algorithm is available. In cases where vast numbers of potential answers exist, one approach, supervised learning, is to label some of the correct answers as valid. This may then be used as training data for the computer to improve the algorithm(s) it uses to determine correct answers. For example, to train a system for the task of word recognition, a dataset of audio/word matches may be used.

In a first stage, training data set 404 (in this case, call data 410, call agent (operator) speech data 412, disclosures 414, etc.)) may be ingested to train various predictive models 406. In a first case example, a disclosure predictive model 422 may be trained based on machine learning engine 402 processing training data set 404. Training a model means learning (determining) values for weights as well as inherent bias from labeled examples. In supervised learning, a machine learning algorithm builds a model by examining many examples and attempting to find a model that minimizes loss; this process is called empirical risk minimization. A language model assigns a probability of a next word in a sequence of words. A conditional language model is a generalization of this idea: it assigns probabilities to a sequence of words given some conditioning context. In this case, the disclosure predictive model is trained to recognize, based on a classification of call agent utterances, a need for the call agent to read a disclosure or an identification of a disclosure currently being read.

In a second stage, the training cycle continuously looks at results, measures accuracy and fine-tunes the inputs to the modeling engine (feedback loop 407) to improve capabilities of the various predictive models 406.

In addition, as various predictive models (algorithms) 406 are created, they are stored in a database (not shown). For example, as the training sets are processed through the machine learning engine 402, the routing predictive model 422 may change (tuning/fine tuning) and therefore may be recorded in the database.

Future new data 408 (e.g., new call data 416, new call agent (operator) speech 418 or new disclosures 420) may be subsequently evaluated with the trained predictive models 406.

In some embodiments, the system may train a disclosure predictive model 422 so that it may predict whether a disclosure is actually being read or is likely in the upcoming utterances. In some embodiments, this is framed as a multi-class classification task. The training data may include calls that contain disclosures. For model training, the system may use the current predictive model to score every utterance of a transcript to produce a disclosure score. The output of the model may be from a static list of classes: the types of disclosures in the system plus one class for no disclosure needed. Once the model is trained, the system may preemptively warn the agent that no disclosure is currently being read. This model may be, for example, an L1 penalized Logistic Regression classifier, trained to identify, for example, one of X disclosures in a snippet of call text. However, any known or future classifier may be substituted without departing from the scope of the technology described herein.

Disclosure compliance predictive model 424 may extract from the call agent's speech utterances to predict whether a disclosure is correctly read during a current call. In one example embodiment, a training set includes a large set of N previous user interactions (call data 410, call agent (operator) speech 412 and disclosures 414). Machine learning engine 402 processes this training set to recognize call agent disclosure interactions that previously resulted in successful outcomes (no errors) based on specific call agent phrasing. Once the disclosure compliance predictive model 424 has been trained to recognize patterns of behavior that resulted in successful behavior, it may take as an input any future behavior and correlate to determine a higher likelihood of successful outcome. For example, the model may provide real-time similar phrasing/actions/options classified by phrasing predictive model 426 as suggestions to assist call agents to complete the disclosure while they are in a current call session. Phrasing predictive model 426 may extract from the call agent's the specific speech utterances words or phrases read incorrectly or not at all (i.e., missing) during a current call and generate one or more corrections to be organized and communicated to the call agent. For example, the phrasing may predict phrasing by including the correct words and may add supportive text, such as introductory phrasing or instructional phrasing. In some embodiments, the supportive text may include an introduction clause that interrupts the current call and indicates that a disclosure needs to be updated or corrected. In some embodiments, the phrasing will be a complete sentence from the disclosure or the entire disclosure. The predictive phrasing model predicts, based on training from previously successful similar disclosure reading corrections, phrasing and supportive text that will complete the disclosure reading such that is it compliant with, for example, regulatory requirements.

The system is a framework that unites several modules to better understand call sequences and help call center agents meet regulatory disclosure compliance.

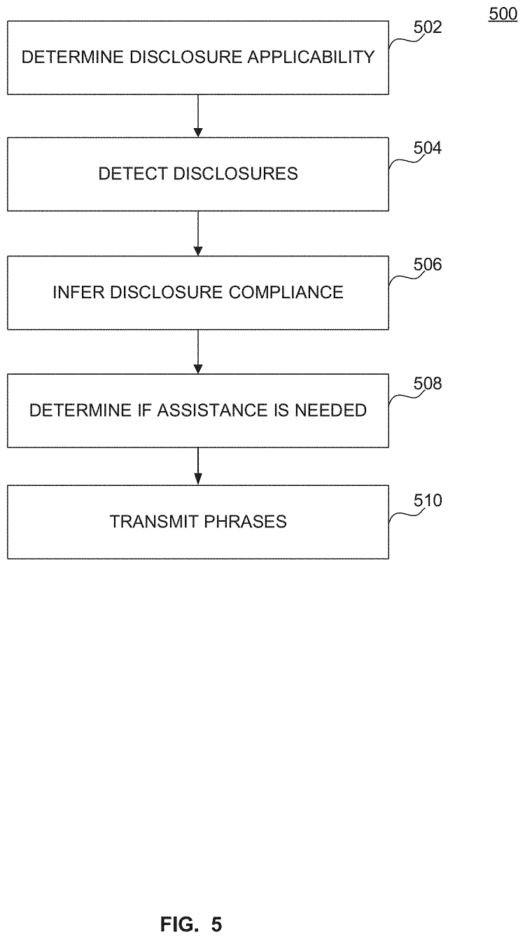

FIG. 5 is a flow diagram for real-time call processing, according to some embodiments. In 502, call center system 100 may forward incoming calls to a call agent based on inferred intelligence.

In 502, call center system 100 may infer/classify the incoming call based on a matching disclosure. A machine learning engine 402 trains a disclosure predictive model 422 to detect disclosure applicability. For example, based on utterances of the caller and/or the call agent, a corresponding “best match” disclosure is selected that should be read during handling of the call. In some embodiments, no “best match” will occur and therefore no notification is required. Alternately, or in addition, the system notifies the call agent that no disclosure is needed.

In 504, call center system 100 may detect disclosures are currently being read in call center transcripts. However, if no disclosure is being read, but is required, based on a best match equaling “Disclosure A”, the system notifies the call agent that disclosure “A” is required. In this scenario, the disclosure may be provided, for example, on a screen of the call agent. In one embodiment, the system performs classification on a turn level (i.e., every time a new utterance is available). Performing this in real-time enables the system to track disclosure changes over the course of a call.

In 506, call center system 100, based on at least a partial disclosure being detected, determines whether a disclosure reading is compliant. For example, the system determines if a disclosure is being read correctly or read with errors (e.g., missing words, numerals or sentences). The system may classify a detected disclosure as compliant based on an exact match of corresponding words of a standard disclosure or allow minor substitutions of similar or equivalent words, an alternate order or minor omissions (e.g., non-critical words).

In 508, call center system 100 may detect a threshold of similarity (compliance score) and subsequently classify the disclosure as compliant or noncompliant (binary decision). In some embodiments, the system may determine if a compliance score exceeds a predetermined threshold and determine that automated agent assistance module 114 is needed to assist the call agent in handling the disclosure reading.

In 510, call center system 100 may suggest phrases that are considered relevant to provide a successful outcome (compliant disclosure reading) and communicate the phrases to call agent 104. For example, call agent will receive phrases displayed on their computer screen. Phrases may include, or be combined with, additional contextual information, such as product descriptions, customer options or steps that may provide assistance.

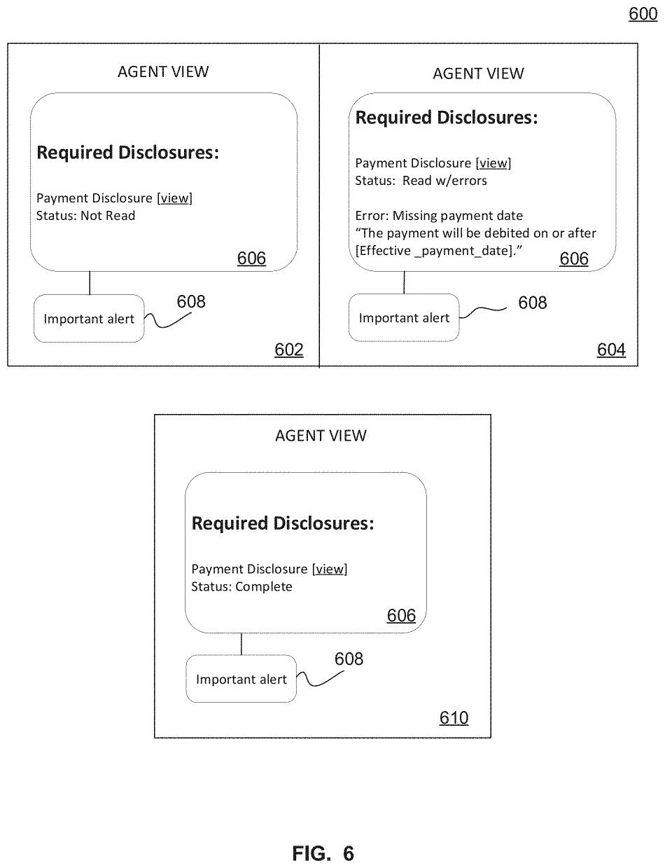

FIG. 6 illustrates multiple examples of real-time support for agents, as per some embodiments. Call agents may only see a simplified view (agent view 602) and feedback 606. The feedback is intended to be used directly in a current conversation. This way, agents do not have to process feedback and reformulate it to sound natural. The feedback may be generated by the system 100 using, for example machine learning system 400 in conjunction with Natural Language Processor 302. On the backend, disclosure compliance may be predicted (shown as detected on right) as the agent reads the required disclosure words or phrases being displayed. An alert 608 may let the agent know of the severity of the error.

To provide actionable assistance, solutions leading to a successful disclosure reading are provided to agents. For example in agent view 602, an indication that a “Payment Disclosure” has not been read is displayed. As shown, a link may be provided to the actual disclosure text.

In agent view 604, an indication is displayed that a “Payment Disclosure” has been read with errors along with specific errors and phrasing to correct—“the payment will be debited on or after . . . ”.

In agent view 610, an indication is displayed that a “Payment Disclosure” has been read completely. In each of these examples, compliance with a reading of regulatory disclosures is confirmed thereby providing an improvement to call center processing technology.

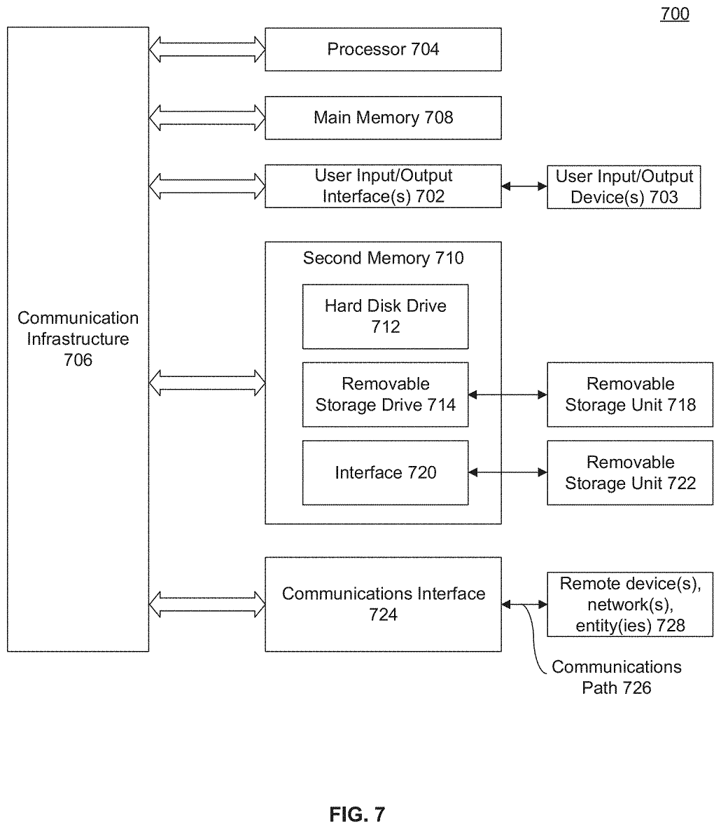

Various embodiments can be implemented, for example, using one or more computer systems, such as computer system 700 shown in FIG. 7. Computer system 700 can be used, for example, to implement method 500 of FIG. 5. Computer system 700 can be any computer capable of performing the functions described herein. Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics-processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 717. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 717 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired, and/or wireless, and which may include any combination of LANs, WANs, the Internet, etc. Control logic and/or data may be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system comprising:
a speech recognizer configured to:
receive an interactive communication between a first participant and a second participant;
extract individual utterances of the first participant; and
convert the individual utterances to a transcript of individual utterances of the first participant;
a machine learning engine configured to:
determine, by a trained machine learning disclosure model and based on the transcript of the interactive communication, that a disclosure is applicable to the interactive communication;
compare, by a trained machine learning disclosure compliance model, the disclosure to the transcript based on subsequently detecting that a part of the disclosure is included in the transcript;
identify one or more errors within the transcript based on the comparing;
determine, based on the one or more errors, that the transcript is non-compliant; and
an automated assistance system configured to:
communicate one or more phrases to the second participant for use in a dialog with the first participant of the interactive communication to correct the one or more errors in the transcript.

2. The system of claim 1, wherein the determining that a disclosure is applicable to the interactive communication further comprises a first classifier to analyze text contained in the transcript.

3. The system of claim 2, wherein the comparing the disclosure to the transcript, based on subsequently detecting that a part of the disclosure is included in the transcript, further comprises a second classifier to analyze text contained in the transcript.

4. The system of claim 1, wherein the disclosure compliance model is further configured to determine that the transcript contains non-compliant information based on a compliance score.

5. The system of claim 4, wherein the compliance score is based on a similarity threshold between text of the disclosure and text of the transcript.

6. The system of claim 4, wherein the system further comprises an alert system configured to provide additional assistance to the dialog when the compliance score is below a similarity threshold.

7. The system of claim 1, wherein the machine learning engine is further configured to:
identify, based on the one or more errors, words or phrases of the disclosure missing from the transcript.

8. The system of claim 1, wherein the machine learning engine is further configured to:
identify numeric information associated with the interactive communication and
identify, based on the one or more errors, that the numeric information associated with the interactive communication is missing from the transcript.

9. The system of claim 1, wherein the machine learning engine is further configured to:
identify, based on the one or more errors, incorrectly spoken words of the disclosure within the transcript.

10. The system of claim 1, wherein the machine learning engine is further configured to:
notify the second participant, during the interactive communication, that the disclosure is applicable to the interactive communication.

11. The system of claim 1, wherein the speech recognizer comprises a natural language processor to convert speech of the interactive communication to text and insert the text into the transcript.

12. A computer implemented method for processing a call, comprising:
determining, by a machine learning speech model, a classification of a current call based on speech detected within the call, wherein the classification identifies a specific regulatory disclosure;
determining, by a machine learning disclosure model, that a portion of the specific regulatory disclosure is included as dialog in the call by a call agent;
determining, by a machine learning disclosure compliance model, that the dialog is non-compliant based on a comparison with the specific regulatory disclosure;
transmitting, by an automated assistance system, one or more phrases to the call agent to correct the dialog during the call.

13. The method of claim 12, further comprising:
identifying words, phrases or sentences of the disclosure missing from the dialog.

14. The method of claim 12, further comprising:
identifying numeric information associated with the current call and
identifying, based on the one or more errors, that the numeric information associated with the current call is missing from the transcript.

15. The method of claim 12, further comprising:
identifying incorrectly spoken words from within the dialog.

16. A non-transitory computer-readable device having instructions stored thereon that, when executed by at least one computing device, cause the at least one computing device to perform operations comprising:
determining, by a machine learning speech model, a classification of a current call based on speech detected within the call, wherein the classification identifies a specific regulatory disclosure;
determining, by a machine learning disclosure model, that a portion of the specific regulatory disclosure is included as dialog in the call by a call agent;
determining, by a machine learning disclosure compliance model, that the dialog is non-compliant based on a comparison with the specific regulatory disclosure;
transmitting, by an automated assistance system, one or more phrases to the call agent to correct the dialog during the call.

17. The non-transitory computer-readable device of claim 16, wherein the determination that the specific regulatory disclosure is noncompliant is based on a compliance score calculated by comparing text of the specific regulatory disclosure and text of the dialog.

18. The non-transitory computer-readable device of claim 17, wherein comparing text is based on a similarity threshold between text of the specific regulatory disclosure and text of the dialog.

19. The non-transitory computer-readable device of claim 16 further configured to perform operations comprising:
identifying words, phrases, or numbers of the specific regulatory disclosure missing from the dialog.

20. The non-transitory computer-readable device of claim 16 further configured to perform operations comprising:
identifying incorrectly spoken words of the specific regulatory disclosure within the dialog.
